(19) United States
(12) Patent Application Publication
(10) Pub. No.: US 2025/0236212 A1
(43) Pub. Date: Jul. 24, 2025

(54) SEAT DEVICE FOR VEHICLE AND CONTROL METHOD THEREOF

(71) Applicant: Honda Motor Co., Ltd., Tokyo (JP)

(72) Inventors: Shogo USUI, Tokyo (JP); Koji HASHIMOTO, Tokyo (JP); Masakazu OKADA, Tokyo (JP)

(73) Assignee: Honda Motor Co., Ltd., Tokyo (JP)

(21) Appl. No.: 18/977,988

(22) Filed: Dec. 12, 2024

(30) Foreign Application Priority Data
Jan. 24, 2024 (CN) 202410098034.2

(51) Int. Cl. B60N 2/00; B60N 2/02; B60N 2/12

(52) U.S. Cl. CPC B60N 2/0026; B60N 2/0244; B60N 2/12

(57) ABSTRACT

The invention provides a seat device for a vehicle and a control method thereof. The seat device for the vehicle includes: an electric device for moving a seat of the vehicle; a pinch detection part detecting an obstacle being pinched by detecting a load change of the electric device when the seat is moved; an obstacle detection part classifying the obstacle in a moving direction of the seat; and a control part controlling the electric device according to a classification of the obstacle.

### CROSS-REFERENCE TO RELATED APPLICATION

This application claims the priority benefit of China application serial no. 202410098034.2, filed on Jan. 24, 2024. The entirety of the above-mentioned patent application is hereby incorporated by reference herein and made a part of this specification.

### BACKGROUND OF THE INVENTION

### Field of the Invention

The invention relates to a seat device for a vehicle and a control method thereof.

### Description of Related Art

In recent years, efforts to provide access to sustainable transportation systems that also take into account vulnerable persons such as the elderly, disabled, and children among traffic participants are growing. In order to achieve the above object, research and development to further improve the safety or convenience of transportation through development related to vehicle habitability are carried out.

Just like the power windows and sunroof of a vehicle may detect pinching, seats detect the positions thereof using motor pulse sensors. When the squeeze caused by the movement of a seat is detected (that is, when the front seat is moved, the rear seat occupant is pinched), the reversal action of the seat is performed. However, when an occupant is pinched, the reversal distance of the seat needed to release the pinched state differs according to the size of the occupant. Also, if there is an item placed between the front seats (driver and passenger seats) and the second row seats (rear seats), even if the reversal action of the seat is performed after the pinch detection, the reversal distance may be insufficient, resulting in the object still being pinched or trapped and unable to be completely freed. Therefore, how to make the seat perform different actions in response to different pinching objects is an issue.

However, in the habitability of the vehicle, it is an issue to make the seat perform different actions in response to different pinching objects when pinching or possible pinching occurs due to the automatic action of the seat.

### SUMMARY OF THE INVENTION

In order to solve the above issues, an object of the present application is to respond to different pinching objects and make a seat perform different actions when pinching or possible pinching occurs due to the automatic action of the seat, so as to contribute to the development of sustainable delivery systems.

Based on the above description, according to an embodiment of the invention, a seat device for a vehicle is provided. The seat device for the vehicle includes: an electric device for moving a seat of the vehicle; a pinch detection part detecting an obstacle being pinched by detecting a load change of the electric device when the seat is moved; an obstacle detection part classifying the obstacle in a moving direction of the seat; and a control part controlling the electric device according to a classification of the obstacle.

According to an embodiment of the invention, in the seat device for the vehicle, the control part stops the electric device before the obstacle is pinched via the classification of the obstacle.

According to an embodiment of the invention, in the seat device for the vehicle, when the pinch detection part detects a pinching of the obstacle, the control part causes the seat to be reversely moved via the electric device, and via the classification of the obstacle, the control part changes a reversal movement amount after the obstacle is pinched.

According to an embodiment of the invention, in the seat device for the vehicle, the seat of the vehicle further includes: a seat cushion part and a seat back part.

Moreover, according to another embodiment of the invention, a control method of a seat device for a vehicle is provided. The seat device has an electric device for moving a seat of the vehicle. The control method includes, detecting an obstacle being pinched by detecting a load change of the electric device when the seat is moved; classifying the obstacle in a moving direction of the seat; and controlling the electric device according to a classification of the obstacle.

According to an embodiment of the invention, the control method further includes: stopping the electric device before the obstacle is pinched based on the classification of the obstacle.

According to an embodiment of the invention, the control method further includes: making the seat perform a reversal movement via the electric device when a pinching of the obstacle is detected; and changing a reversal movement amount after the obstacle is pinched via the classification of the obstacle.

According to an embodiment of the invention, in the control method, the seat of the vehicle further includes: a seat cushion part and a seat back part.

According to an embodiment of the invention, whether the object being pinched (or likely to be pinched) is an adult, a child, or an object may be determined using the obstacle detection part such as a camera or a radar disposed at the interior of the vehicle. Therefore, when pinching is detected, in the case of an adult or an object, a general reversal action of the seat may be performed. If a child is detected, the automatic action of the seat is stopped. Therefore, the seat device of an embodiment of the invention may provide the desired action during the pinch detection for each pinched object without impairing the product functionality thereof.

### BRIEF DESCRIPTION OF THE DRAWINGS

FIG. 1A and FIG. 1B show a schematic structural diagram of a vehicle seat.

FIG. 2 shows a schematic diagram of the architecture of detecting an obstacle inside a vehicle.

FIG. 3A and FIG. 3B show the pinching situation caused by seat movement.

FIG. 4 shows a schematic diagram of the architecture of a vehicle seat device according to an embodiment of the invention.

FIG. 5 shows a logical conceptual diagram for determining pinching according to an embodiment of the invention.

FIG. 6A and FIG. 6B illustrate the relationship between motor speed and motor load when pinching occurs.

FIG. 7A and FIG. 7B illustrate changes in motor speed in the absence and presence of external force.

FIG. 8A to FIG. 8C illustrate a control method of a seat corresponding to various classifications according to an embodiment of the invention.

FIG. 9 shows a schematic flowchart of the control process of a vehicle seat according to an embodiment of the invention.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and descriptions to refer to the same or like parts.

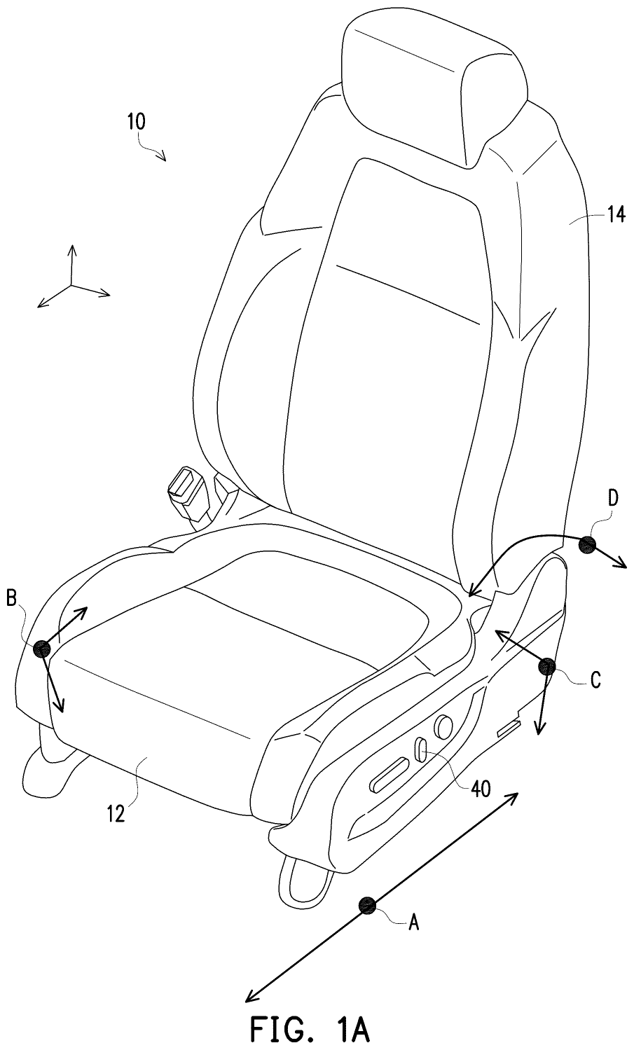

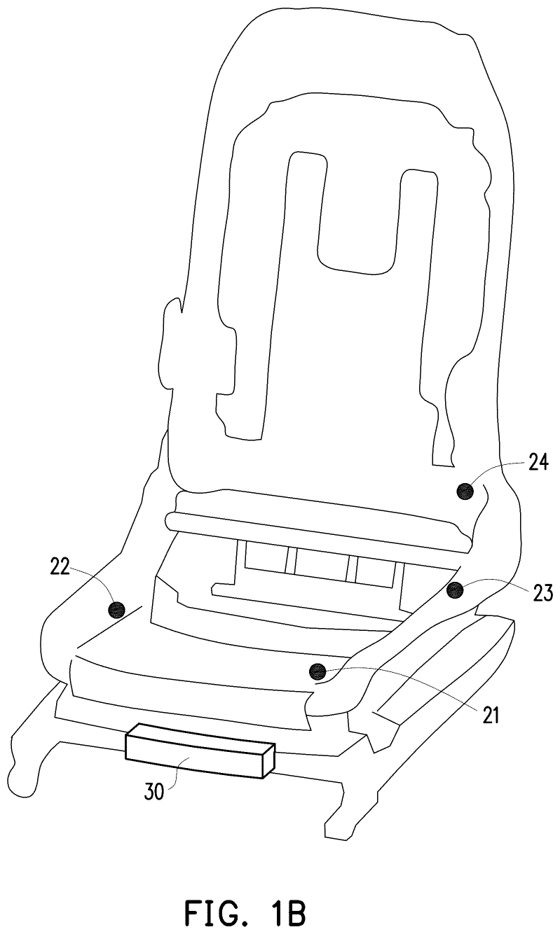

FIG. 1A and FIG. 1B show a schematic structural diagram of a vehicle seat. As shown in FIG. 1A and FIG. 1B, as one example, a seat 10 of a vehicle may include a seat cushion part 12 and a seat back part 14. In addition, the seat cushion part 12 and the seat back part 14 may be pivotally connected together. In general, the seat 10 is disposed at the interior of the vehicle. The seat disposed at the front of the vehicle may at least includes seats for the driver and the front passenger. In general, the seats of the vehicle may provide at least four directions of movement or rotation, such as the overall forward and backward movement of the seat 10, the overall up and down movement of the seat 10, the tilting movement of the front end of the seat cushion part 12, and the forward and backward tilting movement of the seat back part 14. Of course, in a higher-end seat 10, more directions of movement may be provided.

As shown in FIG. 1A and FIG. 1B, this seat 10 is slidably mounted on the floor of the interior of the vehicle, so that the seat 10 may be moved forward and backward along a direction A (substantially coinciding with the front-rear direction of the vehicle) via a motor 21. The seat 10 may move (tilt) the front end of the seat cushion part 12 up and down in a direction B via a motor 22. The seat 10 may be moved up and down in a direction C (that is, the height direction) via a motor 23, so as to adjust the height of the seat 10. Therefore, the seat back part 14 may be rotated in a direction D via a motor 24, that is, the seat back part 14 may be tilted backward or tilted forward.

As one embodiment, the seat 10 may also be provided with a controller 30, such as a seat control ECU (Electric Control Unit). The controller 30 is composed of, for example, a processor to receive a user instruction (for example, the user may operate a switch group 40 disposed on the seat 10) to control at least one of the motors 21 to 24 to adjust the posture of the seat 10. The controller 30 as the seat control ECU is also used to execute control programs described later. In addition, these control programs may also be controlled via the core ECU of the vehicle. The core ECU may receive detection signals from various sensors disposed in a vehicle V and perform a corresponding control procedure via calculation.

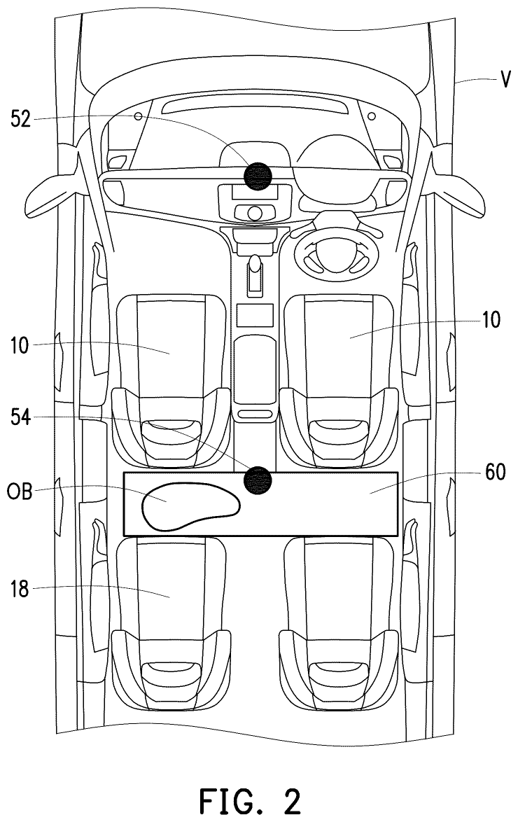

FIG. 2 shows a schematic diagram of the architecture of detecting an obstacle inside a vehicle. As shown in FIG. 2, detection devices 52 and 54 for detecting an obstacle OB are disposed indoors of the vehicle V. These detection devices 52 and 54 may be, for example, cameras or radars. As one example, a camera or a radar, etc. may be disposed in the roof lining of the vehicle V, or may of course be disposed at other suitable places of the interior of the vehicle V. As one example of an embodiment of the invention, the cameras or radars 52 and 54 may detect inside a detection area 60 between the front seat 10 and a rear seat 18 to determine whether the obstacle OB is present in the detection area 60.

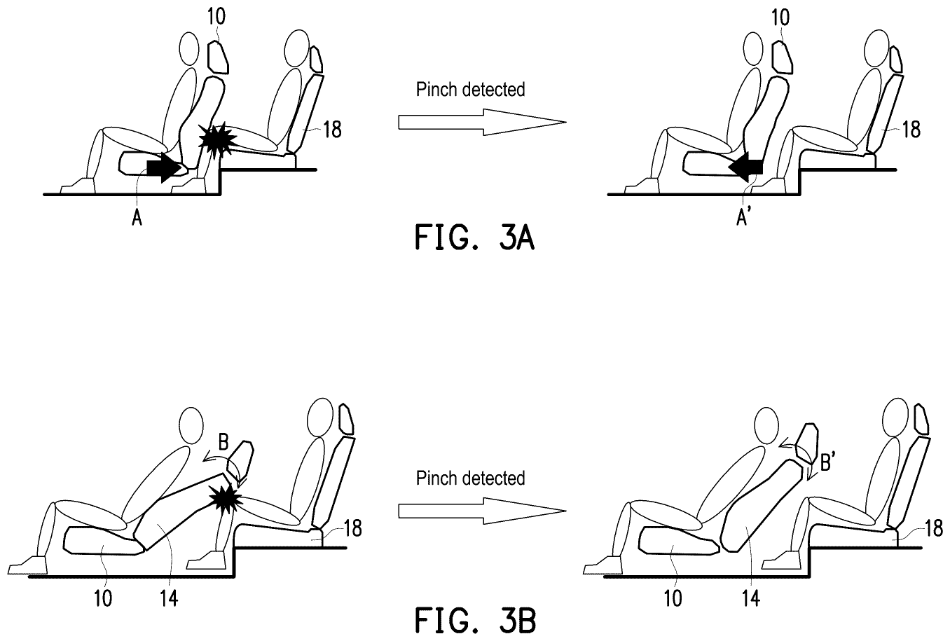

FIG. 3A and FIG. 3B show a pinching situation caused by seat movement. As shown in FIG. 3A, when the front driver or passenger adjusts the seat 10 to move backward along the direction A, the seat 10 may pinch the occupant of the rear seat 18. At this time, the controller 30, serving as the seat control ECU, may control the motor 21 (see FIG. 1B) of the seat 10 to move the seat 10 forward a specified distance along a direction A′ opposite to the direction A to relieve the seat 10 from pinching the occupant of the rear seat 18. Similarly, as shown in FIG. 3B, when the current driver or passenger adjusts the seat 10 along the direction D to tilt the seat back part 14 backward, the seat 10 may pinch the occupant of the rear seat 18. At this time, the controller 30, serving as the seat control ECU, may control the motor 24 (see FIG. 1B) of the seat 10 to make the seat back part 14 of the seat 10 fall forward a specified distance along a direction D′ opposite to the direction D to relieve the seat 10 from pinching the occupant of the rear seat 18.

According to an embodiment of the invention, when there is an obstacle between the front seat 10 and the rear seat 18, the seat 10 is further controlled to avoid the obstacle OB and the rear occupant from being pinched. This control method is further explained below.

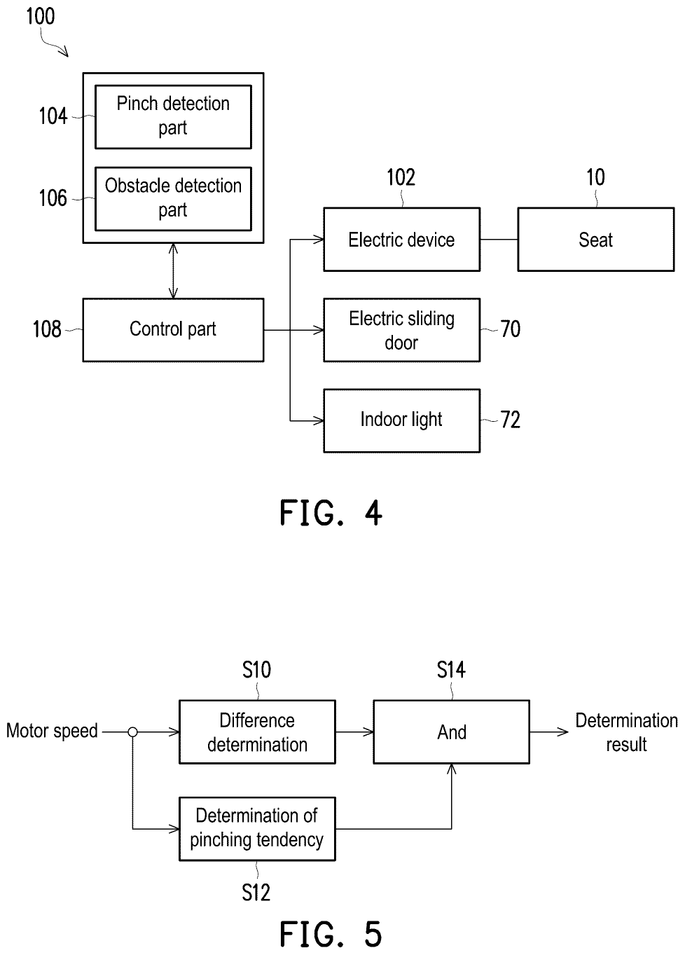

FIG. 4 shows a block diagram of a seat device for a vehicle according to an embodiment of the invention. As shown in FIG. 1A and FIG. 1B to FIG. 4, a seat device 100 may architecturally include an electric device 102, a pinch detection part 104, an obstacle detection part 106, and a control part 108. The electric device 102 is used to move the seat 10 of the vehicle V, that is, to control the movement of the seat 10 in the directions A to D shown in FIG. 1A. The electric device 102 may be formed by the motors 21 to 24 shown in FIG. 1B.

In addition, the pinch detection part 104 is configured to detect whether the obstacle OB is pinched by detecting the load change (i.e., the difference of motor speed) of the electric device 102 when the seat 10 is moved. The motor speed here may refer to any of the motors 21 to 24 mounted on the seat 10 or a combination thereof. The obstacle OB is usually pinched when the seat 10 moves forward or backward or the seat back part 14 falls backward. Therefore, for example, the speed change of the motors 21 and 24 may be detected via the seat control ECU shown in FIG. 1B to determine the change of the pinch load on the obstacle OB.

The obstacle detection part 106 detects the obstacle OB is present in the moving direction of the seat 10. That is, as shown in FIG. 2, the detection devices 52 and 54 such as cameras or radars in the vehicle V may detect whether the obstacle OB is present in the detection area 60. Of course, the camera or the radar as the obstacle detection part 106 may also detect the occupant of the rear seat 18. In addition, the obstacle detection part 106 may further classify the detected obstacle OB or occupant.

For example, the obstacle detection part 106 may analyze the acquired image signal or radar signal to determine the size of the obstacle. The obstacle detection part 106 may also determine whether the obstacle OB has a heartbeat. Therefore, the obstacle detection part 106 may determine whether the obstacle OB is an object (for example, not having a heartbeat) or a child (according to only the measured size and whether a heartbeat is detected). Furthermore, the obstacle detection part 106 may also determine whether the rear passenger is an adult or a child. Therefore, the obstacle detection part 106 may classify the obstacle OB in the moving direction of the seat 10, such as an object, a child, an adult, or other things, etc.

FIG. 5 shows a logical conceptual diagram for determining pinching according to an embodiment of the invention. As shown in FIG. 5, after the motor speed is received (for example, via the controller 30 serving as the seat control ECU), the control part 108 performs the difference value determination of step S10 and the pinching tendency determination of step S12. Lastly, in step S14, the determination results of steps S10 and S12 are combined to output the determination result of the seat 10 pinching the obstacle 10. That is, when the seat 10 pinches the obstacle OB or the occupant of the rear seat 18, the rotation speed of the motor (such as the motors 21 to 24, etc.) is reduced. Then, the difference (i.e., equivalent to the differential value) of speed reduction may be calculated. Then, whether the difference exceeds a predetermined determination threshold value is determined, and when the difference value shows a pinching tendency, it is determined that pinching occurs.

Regarding step S10, when making a difference determination, that is, when making a difference determination of the motor speed, a difference A of the motor speed is calculated at a certain count (such as every period of time). When the difference A exceeds the predetermined determination threshold value, it is determined that pinching occurs.

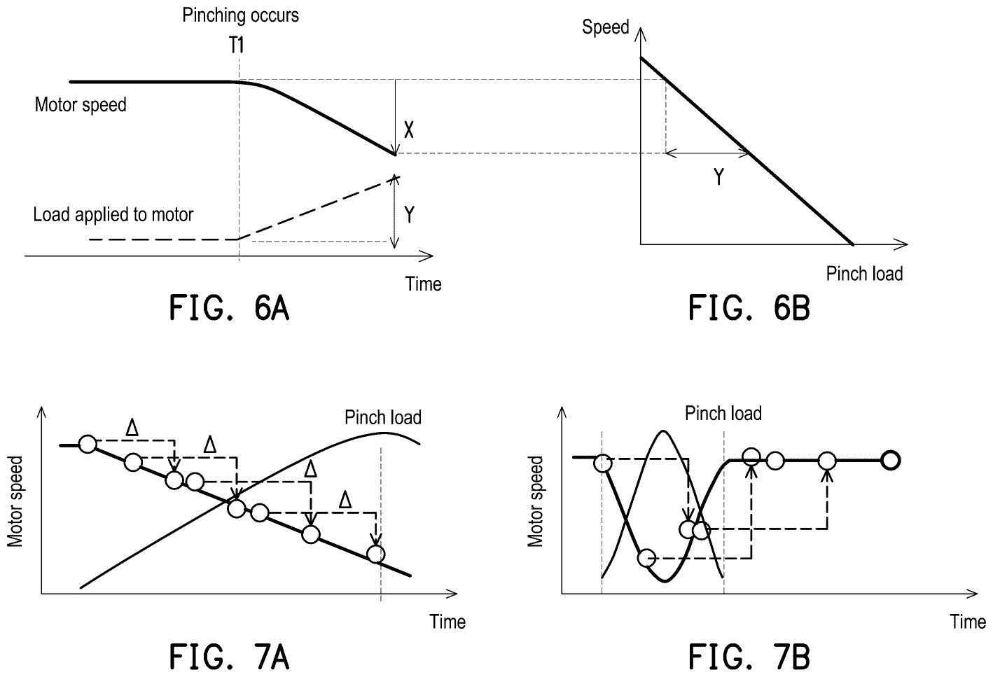

As shown in FIG. 6A and FIG. 6B, when pinching occurs at time T1, the motor speed begins to be decreased as time is increased, wherein X is the reduction of motor speed caused by pinching. At the same time, the load (estimated value) applied to the motor also begins to be increased as time is increased, wherein Y is the increase in the load on the obstacle caused by pinching. Therefore, using the characteristic curve of the motor, the pinch load on the obstacle OB may be estimated from the change of the motor speed.

Also, whether a pinch occurs is determine only using the difference of motor speed, the motor speed may be changed significantly (for example, a passenger suddenly sits up, etc.) due to external force input of local interference, thus leading to erroneous determination. Therefore, in the invention, when the pinching tendency is further determined via step S12, the difference of motor speed calculated each time is compared first for a period of time. If the difference remains substantially constant, it may be determined that pinching occurs.

As shown in FIG. 7A, the difference A of each motor speed calculated at each period of time remains substantially constant, and the increase of the pinch load when pinching occurs takes a longer time to change. As shown in FIG. 7B, the pinch load caused by external force interference is changed significantly in a short period of time. Therefore, whether there is a tendency for pinching may be analyzed using measurement data from past measurements.

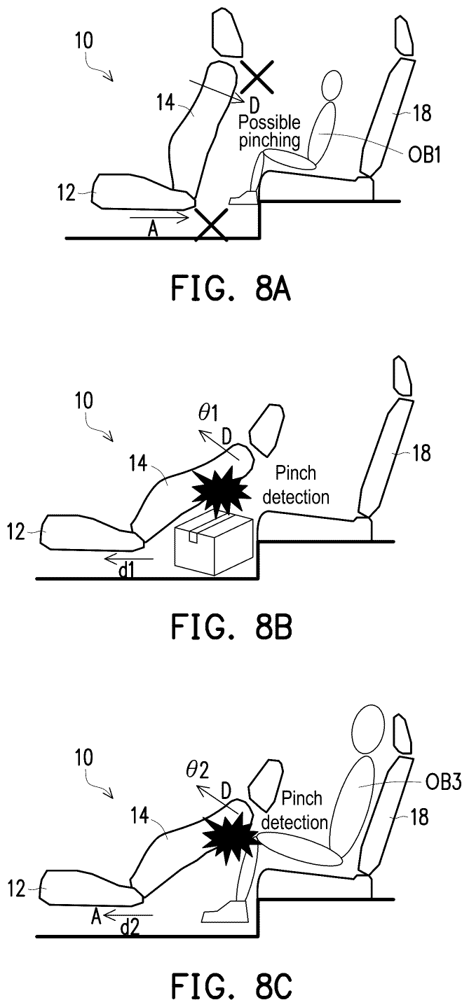

The control part 108 may be implemented by the controller 30 of the seat control ECU, or may be implemented by the core ECU of the vehicle. Here, the control part 108 may generate a control signal for controlling the electric device 102 based on the detection results (i.e., classification results) from the pinch detection part 104 and the obstacle detection part 106, so as to make the seat 10 perform corresponding actions. Here, the control part 108 may control the electric device 102 (that is, the seat) according to the classification of the obstacle OB. This control includes, for example, forward and backward movement of the entire seat 10, forward movement (rotation) of the seat back part 14, and stopping the action of the seat 10, etc. Next, the control method of the seat 10 corresponding to various classifications of an embodiment of the invention is described with reference to FIG. 8A to FIG. 8C.

As shown in FIG. 8A, the detection result (that is, the classification result) of the obstacle detection part 106 classifies an obstacle OB1 into a child. Based on the classification result, the control part 108 generates a control signal to control the electric device 102 to stop the action thereof. That is, the control part 108 stops the automatic action (rearward movement and reclining) of the seat 10 to ensure the safety of the child.

Furthermore, as shown in FIG. 8B, the detection result (that is, the classification result) of the obstacle detection part 106 determines that an obstacle OB2 is an object of a general article. Objects generally do not move. Therefore, when the obstacle detection part 106 classifies the obstacle OB2 as an object or the like, the control part 108 generates a control signal to control the electric device 102 based on the classification, thereby causing the electric device 102 to be reversed. That is, the control part 108 causes the automatic action of the seat 10 to perform a reversal action. In this example, the entire seat 10 performs the reversal action along an A direction by a predetermined reversal movement amount d1. At the same time, the seat back part 14 of the seat 10 may perform the reversal action along a D direction by a predetermined reversal movement amount θ1, so that the seat back part 14 may be moved (rotated) forward. As a result, the object of the obstacle OB2 may be released. In addition, the reversal movement amount d1 and the reversal movement amount θ1 may be called the first reversal movement amount.

Furthermore, as shown in FIG. 8C, the detection result (that is, the classification result) of the obstacle detection part 106 determines that an obstacle OB3 is an adult. Therefore, when the obstacle detection part 106 classifies the obstacle OB3 as an adult or the like, the control part 108 generates a control signal to control the electric device 102 based on the classification, thereby causing the electric device 102 to be reversed. That is, the control part 108 causes the automatic action of the seat 10 to perform the reversal action. In this example, the entire seat 10 performs the reversal action along the A direction by a predetermined reversal movement amount d2. At the same time, the seat back part 14 of the seat 10 may perform the reversal action along the D direction by a predetermined reversal movement amount θ2, so that the seat back part 14 may be moved (rotated) forward. Accordingly, the seat 10 does not pinch the rear seat occupant. In addition, the reversal movement amount d2 and the reversal movement amount θ2 may be collectively referred to as the second reversal movement amount. Moreover, since adults are less affected by pinching and squeezing, and there is no need to eliminate the object as the obstacle OB2 as shown in FIG. 8B, it is only necessary to prevent the seat 10 from pinching the occupant. Therefore, the second reversal movement amount may be set to be less than the first reversal movement amount.

In summary, when the pinch detection part 106 detects the pinched obstacle OB, the control part 108 causes the seat 10 to perform reversal movement via the electric device 102. Moreover, in a case in which the obstacle is not a child, by classifying the obstacle OB, the control part 102 further changes the reversal movement amount after the obstacle OB is pinched, that is, the first reversal movement amount or the second reversal movement amount above.

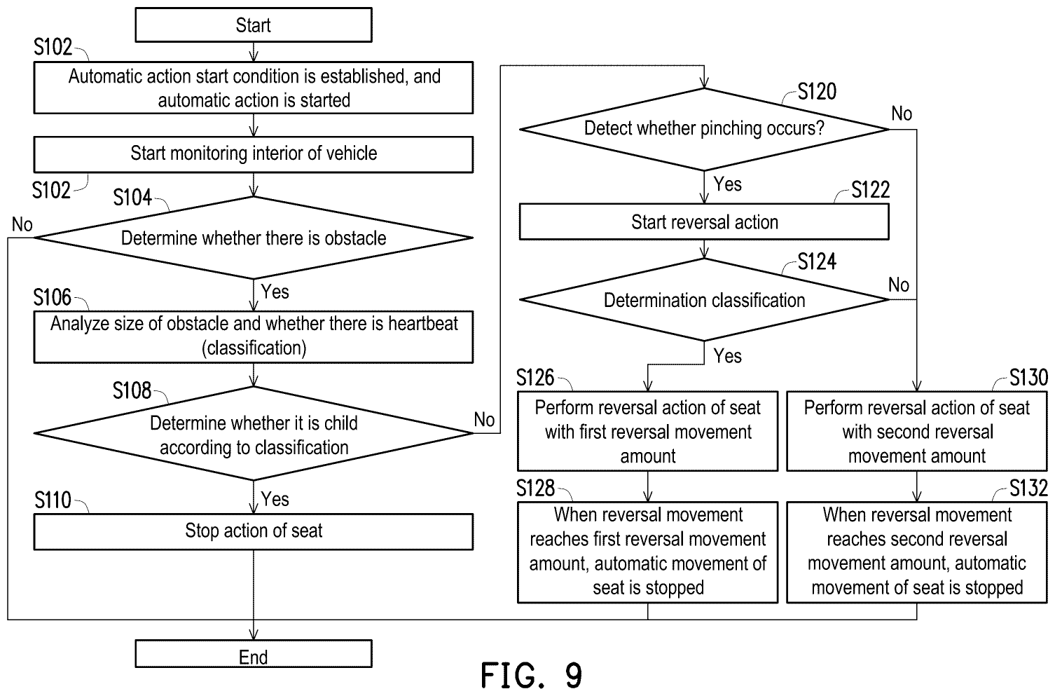

FIG. 9 shows a schematic flowchart of the control process of a vehicle seat according to an embodiment of the invention. As shown in FIG. 9, in step S100, an automatic action start condition is established and an automatic action is started. The automatic action here may refer to an automatic adjustment action of the seat 10 of the vehicle V, which is an automatic movement in at least four directions of A to D as shown in FIG. 1A.

In step S102, the monitoring of the interior of the vehicle V is started using a camera or a radar as the detection devices 52 and 54 in the vehicle V. A camera or a radar is an example of the obstacle detection part 106. In addition to detecting the obstacle OB, the camera or the radar may also be used to detect and determine whether there is a passenger sitting in the rear seat 18.

In step S104, at this time, the obstacle detection part 106 may detect the inside of the detection area 60 in the vehicle V to determine whether the obstacle OB is present, that is, whether or not the obstacle OB is present between the front seat 10 and the rear seat 18 is detected.

When it is determined in step S104 that the obstacle OB is present, step S106 is executed to classify the detected obstacle OB. On the contrary, when it is determined in step S104 that the obstacle OB is not present, the control flow ends.

In step S106, the obstacle detection part 106 further classifies the obstacle OB. Here, the size of the obstacle OB between the front and rear seats is detected, for example, by a camera or a radar. For the camera, the acquired image may be processed to determine the size of the obstacle OB. The radar may detect the distance to each part of the obstacle OB to determine the size of the obstacle OB.

In addition, the camera or the radar continuously captures or measures the distance of the obstacle OB between the front and rear seats to determine whether the obstacle OB is moving. Accordingly, whether the obstacle OB is a simple immobile object or a movable creature (such as a child, etc.) may be determined. Moreover, a life sign detection device may also be used to detect whether the obstacle OB has a heartbeat, so as to determine whether the obstacle OB is a simple immobile object or an active creature (such as a child, etc.) Thus, the obstacle OB may be classified as a child, a general object, an adult, or others.

In step S108, if it is determined that the obstacle OB is a child, step S110 is executed, and the control part 108 controls the action of the electric device 102 to stop the electric device 102, that is, the seat 10 stops moving so that the seat 10 does not pinch the child. Then, this control flow is stopped.

On the contrary, if step S108 determines that the obstacle OB is not a child, step S120 is executed to determine whether pinching is detected. Whether pinching is detected may be determined by using the method described in FIG. 5, FIG. 6A, and FIG. 6B.

When it is determined in step S120 that pinching is detected, the control part 108 starts controlling the electric device 102 to make the seat 10 start performing a reversal action.

Next, in step S124, the identity of the obstacle OB is determined according to the classification result of step S106. If step S124 determines that the obstacle OB is an object, step S126 is executed. In step S126, the control part 108 controls the electric device 120 to make the seat 10 perform a reversal action with a first reversal movement amount.

Next, in step S128, when the seat 10 performs the reversal action and reaches a predetermined distance (i.e., the first reversal movement amount), the movement of the seat 10 is stopped, that is, the automatic adjustment action of the seat 10 is stopped, and the control process ends. For example, for the forward and backward movement of the seat 10, the predetermined distance is a linear distance, and for the forward and backward movement (rotation) of the seat back part 14 of the seat 10, the predetermined distance is a rotation angle (or an arc distance of movement). In addition, this predetermined distance (first reversal movement amount) may be set in advance in the controller, or may be set by the user. Then, this control flow is stopped.

On the contrary, when it is determined in step S124 that the obstacle OB is not an object, but may be an adult or others, step S130 is executed. In step S130, the control part 108 controls the electric device 120 to make the seat 10 perform a reversal action with a second reversal movement amount. In particular, the second reversal movement amount is less than the first reversal movement amount.

Next, in step S132, when the seat 10 performs the reversal action and reaches a predetermined distance (i.e., the second reversal movement amount), the movement of the seat 10 is stopped, that is, the automatic adjustment action of the seat 10 is stopped, and the control process ends. For example, for the forward and backward movement of the seat 10, the predetermined distance is a linear distance, and for the forward and backward movement (rotation) of the seat back part 14 of the seat 10, the predetermined distance is a rotation angle (or an arc distance of movement). In addition, this predetermined distance (second reversal movement amount) may be set in advance in the controller, or may be set by the user. Then, this control flow is stopped.

Based on the above, according to an embodiment of the invention described above, the camera or the radar disposed at the interior of the vehicle may be used to detect the size of the object being pinched (or potentially pinched) and whether there is a heartbeat to determine whether the obstacle is an adult, a child, or an object. Therefore, when pinching is detected, in the case of an adult or an object, a general reversal action of the seat may be performed. If a child is detected, the automatic action of the seat is stopped. Therefore, the seat device of an embodiment of the invention may provide the desired action during the pinch detection for each pinched object without impairing the product functionality thereof.

Lastly, it should be noted that the above embodiments are used to describe the technical solution of the invention instead of limiting it. Although the invention has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the invention.

What is claimed is:

1. A seat device for a vehicle, comprising:
an electric device for moving a seat of the vehicle;
a pinch detection part detecting an obstacle being pinched by detecting a load change of the electric device when the seat is moved;
an obstacle detection part classifying the obstacle in a moving direction of the seat; and
a control part controlling the electric device according to a classification of the obstacle.

2. The seat device for the vehicle of claim 1, wherein
the control part stops the electric device via the classification of the obstacle before the obstacle is pinched.

3. The seat device for the vehicle of claim 2, wherein,
in response to the pinch detection part detecting a pinching of the obstacle, the control part makes the seat perform a reversal movement via the electric device, and
the control part changes a reversal movement amount via the classification of the obstacle after the obstacle is pinched.

4. The seat device for the vehicle of claim 2, wherein,
the seat of the vehicle further comprises a seat cushion part and a seat back part.

5. The seat device for the vehicle of claim 1, wherein,
in response to the pinch detection part detecting a pinching of the obstacle, the control part makes the seat perform a reversal movement via the electric device, and
the control part changes a reversal movement amount via the classification of the obstacle after the obstacle is pinched.

6. The seat device for the vehicle of claim 1, wherein,
the seat of the vehicle further comprises a seat cushion part and a seat back part.

7. A control method of a seat device for a vehicle, wherein the seat device has an electric device for moving a seat of the vehicle, the method comprising:
detecting an obstacle being pinched by detecting a load change of the electric device when the seat is moved;
classifying the obstacle in a moving direction of the seat; and
controlling the electric device according to a classification of the obstacle.

8. The control method of the seat device for the vehicle of claim 7, further comprising:
stopping the electric device before the obstacle is pinched via the classification of the obstacle.

9. The control method of the seat device for the vehicle of claim 8, further comprising:
making the seat perform a reversal movement via the electric device in response to the pinch detection part detecting a pinching of the obstacle; and
changing a reversal movement amount after the obstacle is pinched via the classification of the obstacle.

10. The control method of the seat device for the vehicle of claim 8, wherein,
the seat of the vehicle further comprises a seat cushion part and a seat back part.

11. The control method of the seat device for the vehicle of claim 7, further comprising:
making the seat perform a reversal movement via the electric device in response to the pinch detection part detecting a pinching of the obstacle; and
changing a reversal movement amount after the obstacle is pinched via the classification of the obstacle.

12. The control method of the seat device for the vehicle of claim 7, wherein,
the seat of the vehicle further comprises a seat cushion part and a seat back part.
